(19) United States
(12) Patent Application Publication
(10) Pub. No.: US 2025/0223133 A1
(43) Pub. Date: Jul. 10, 2025

(54) CLEARANCE MEASUREMENT DEVICE FOR COUNTERWEIGHT OF ELEVATOR

(71) Applicant: Mitsubishi Electric Corporation, Tokyo (JP)

(72) Inventor: Hironori INAYOSHI, Tokyo (JP)

(73) Assignee: Mitsubishi Electric Corporation, Tokyo (JP)

(21) Appl. No.: 18/853,143

(22) PCT Filed: Apr. 6, 2022
(86) PCT No.: PCT/JP2022/017184

§ 371 Date: Oct. 1, 2024

(51) Int. Cl. B66B 5/00; B66B 5/12

(52) U.S. Cl. CPC B66B 5/0087; B66B 5/0025; B66B 5/12

(57) ABSTRACT

Obtained is a clearance measurement device for a counterweight of an elevator, which enables measurement of a clearance for a counterweight without removal of a protective cover. This clearance measurement device for a counterweight of an elevator includes: a level meter; and a holding part that is provided to a protective cover and holds the level meter in such a manner that the level meter is movable in an up-and-down direction with respect to the protective cover. The level meter includes: a receiving portion to be pushed by a counterweight from above; a mark portion that is provided to the receiving portion and is configured to indicate a position of a lower end portion of the counterweight; and a guide portion configured to guide the receiving portion and the mark portion along the protective cover.

### TECHNICAL FIELD

This disclosure relates to a clearance measurement device for a counterweight of an elevator.

### BACKGROUND ART

Hitherto, there has been known a clearance measurement method for a counterweight of an elevator, which uses a scale sticker provided on a side wall of a pit in the vicinity of a counterweight buffer to measure a clearance dimension for a counterweight (see, for example, Patent Literature 1).

### CITATION LIST

### Patent Literature

[PTL 1] JP 11-92056 A

### SUMMARY OF INVENTION

### Technical Problem

However, a protective cover is provided in the vicinity of the counterweight buffer. When a car is on a top floor, the clearance for the counterweight is covered with the protective cover. Thus, with the method described in Patent Literature 1, there arises a problem in that the protective cover is required to be temporarily removed when the clearance dimension for the counterweight is to be measured.

This disclosure has been made to solve the problem described above, and has an object to provide a clearance measurement device for a counterweight of an elevator, which enables measurement of a clearance dimension for a counterweight without removal of a protective cover.

### Solution to Problem

A clearance measurement device for a counterweight of an elevator according to this disclosure includes: a level meter; and a holding part that is provided to a protective cover and holds the level meter in such a manner that the level meter is movable in an up-and-down direction with respect to the protective cover. The level meter includes: a receiving portion to be pushed by a counterweight from above; a mark portion that is provided to the receiving portion and is configured to indicate a position of a lower end portion of the counterweight; and a guide portion configured to guide the receiving portion and the mark portion along the protective cover.

### Advantageous Effects of Invention

The clearance measurement device for a counterweight of an elevator according to this disclosure enables measurement of a clearance dimension for the counterweight without removal of the protective cover.

### BRIEF DESCRIPTION OF DRAWINGS

FIG. 1 is a configuration diagram for illustrating an elevator to which a clearance measurement device for a counterweight of an elevator according to a first embodiment is mounted.

FIG. 2 is a perspective view for illustrating a counterweight and a protective cover of FIG. 1.

FIG. 3 is a front view for illustrating the clearance measurement device for a counterweight of an elevator according to the first embodiment immediately after installation of the elevator.

FIG. 4 is a sectional view taken along the line IV-IV of FIG. 3 when viewed in a direction indicated by the arrows.

FIG. 5 is a front view for illustrating a level meter of FIG. 3.

FIG. 6 is a plan view for illustrating the level meter of FIG. 5.

FIG. 7 is a side view for illustrating the level meter of FIG. 5.

FIG. 8 is a front view for illustrating the clearance measurement device for a counterweight of an elevator according to the first embodiment after aging of the elevator occurs.

FIG. 9 is a front view for illustrating a clearance measurement device for a counterweight of an elevator according to a second embodiment.

FIG. 10 is a sectional view taken along the line X-X of FIG. 9 when viewed in a direction indicated by the arrows.

FIG. 11 is a sectional view taken along the line XI-XI of FIG. 9 when viewed in a direction indicated by the arrows.

FIG. 12 is a front view for illustrating a clearance measurement device for a counterweight of an elevator according to a third embodiment.

FIG. 13 is a sectional view taken along the line XIII-XIII of FIG. 12 when viewed in a direction indicated by the arrows.

FIG. 14 is a front view for illustrating a clearance measurement device for a counterweight of an elevator according to a fourth embodiment immediately after installation of the elevator.

FIG. 15 is a sectional view taken along the line XV-XV of FIG. 14 when viewed in a direction indicated by the arrows.

FIG. 16 is a front view for illustrating the clearance measurement device for a counterweight of an elevator according to the fourth embodiment after aging of the elevator occurs.

FIG. 17 is a front view for illustrating a clearance measurement device for a counterweight of an elevator according to a fifth embodiment.

FIG. 18 is a sectional view taken along the line XVIII-XVIII of FIG. 17 when viewed in a direction indicated by the arrows.

### DESCRIPTION OF EMBODIMENTS

### First Embodiment

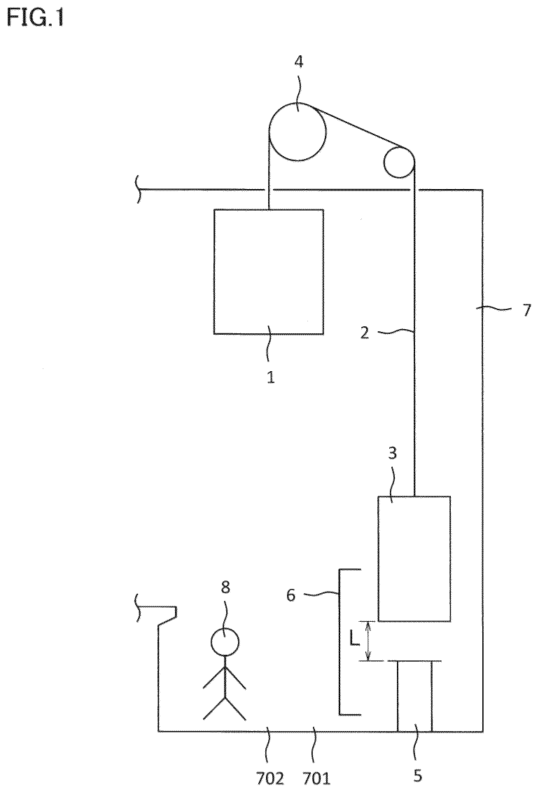

FIG. 1 is a configuration diagram for illustrating an elevator to which a clearance measurement device for a counterweight of an elevator according to a first embodiment is mounted. The elevator includes a car 1, a main rope 2, a counterweight 3, a hoisting machine 4, a counterweight buffer 5, and a protective cover 6.

One end portion of the main rope 2 in a longitudinal direction of the main rope 2 is connected to an upper end portion of the car 1. The other end portion of the main rope 2 in the longitudinal direction of the main rope 2 is connected to an upper end portion of the counterweight 3.

An intermediate portion of the main rope 2 in the longitudinal direction of the main rope 2 is wound around the hoisting machine 4. When the hoisting machine 4 is driven, the main rope 2 is moved. When the main rope 2 is moved, the car 1 and the counterweight 3 are raised and lowered in opposite directions inside a hoistway 7.

The counterweight buffer 5 is provided in a pit 701 of the hoistway 7. The protective cover 6 is provided in the vicinity of the counterweight buffer 5. The protective cover 6 is made of, for example, a resin. An area in the pit 701, which is located on a side opposite to the counterweight 3 with respect to the protective cover 6, is defined as an in-pit work area 702.

In FIG. 1, there is illustrated a state of the elevator when the car 1 is on a top floor. When the car 1 is on the top floor, a distance from the counterweight 3 to the counterweight buffer 5 is the shortest. The distance between the counterweight 3 and the counterweight buffer 5 when the car 1 is on the top floor is defined as a clearance dimension L for the counterweight 3. A worker 8 measures the clearance dimension L for the counterweight 3 while being in the in-pit work area 702.

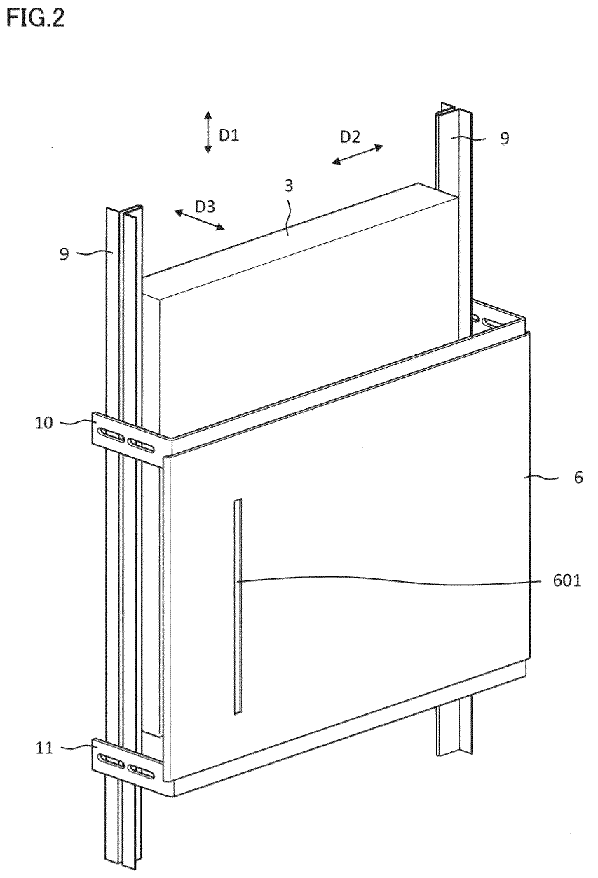

FIG. 2 is a perspective view for illustrating the counterweight 3 and the protective cover 6 of FIG. 1. A pair of counterweight guide rails 9 are provided in the hoistway 7.

The pair of counterweight guide rails 9 extend in an up-and-down direction D1. The pair of counterweight guide rails 9 are arranged so as to be spaced apart from each other in a width direction D2 of the counterweight 3. The pair of counterweigh guide rails 9 are arranged so as to be opposed to each other in the width direction D2.

The counterweight 3 is arranged between the pair of counterweight guide rails 9. The counterweight 3 is raised and lowered in the up-and-down direction D1 inside the hoistway 7 while being guided along the pair of counterweight guide rails 9.

An upper mounting arm 10 and a lower mounting arm 11 are provided so as to extend from one of the pair of counterweight guide rails 9 to the other one thereof. The upper mounting arm 10 is arranged above the lower mounting arm 11. The upper mounting arm 10 is mounted to the pair of counterweight guide rails 9. The lower mounting arm 11 is mounted to the pair of counterweight guide rails 9. An upper part of the protective cover 6 is mounted to the upper mounting arm 10. A lower part of the protective cover 6 is mounted to the lower mounting arm 11.

A slit 601 is formed in the protective cover 6. The slit 601 passes through the protective cover 6 in a thickness direction D3 of the protective cover 6. The slit 601 extends in the up-and-down direction D1.

The protective cover 6 is arranged so as to be opposed to a lower end portion of the counterweight 3 in the thickness direction D3 of the counterweight 3 when the car 1 is on the top floor. When the protective cover 6 is removed from the upper mounting arm 10 and the lower mounting arm 11 while the car 1 is on the top floor, a part of the lower end portion of the counterweight 3, which is on a side closer to the in-pit work area 702, is exposed. As a result, the lower end portion of the counterweight 3 can be visually checked by the worker 8 from the in-pit work area 702.

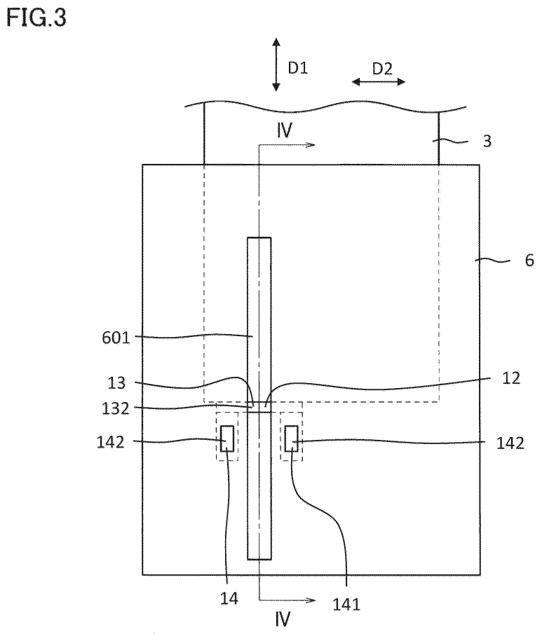

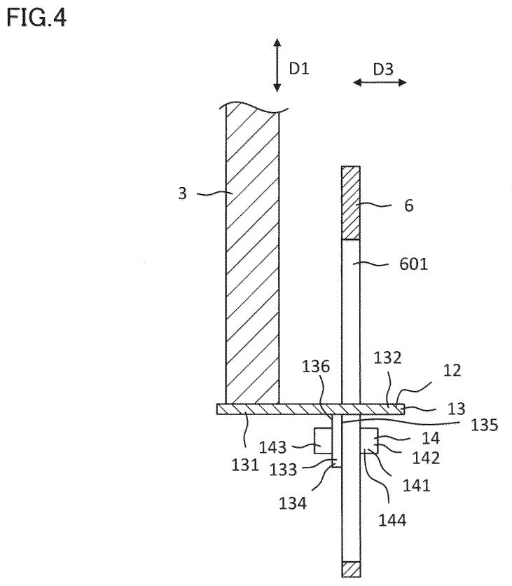

FIG. 3 is a front view for illustrating a clearance measurement device 12 for the counterweight 3 of the elevator according to the first embodiment immediately after installation of the elevator. FIG. 4 is a sectional view taken along the line IV-IV of FIG. 3 when viewed in a direction indicated by the arrows. In FIG. 3 and FIG. 4, the clearance measurement device 12 for the counterweight 3 of the elevator when the car 1 is on the top floor is illustrated.

The clearance measurement device 12 for the counterweight 3 of the elevator according to the first embodiment includes a level meter 13 and a holding part 14. The level meter 13 includes a receiving portion 131, a mark portion 132, and a guide portion 133.

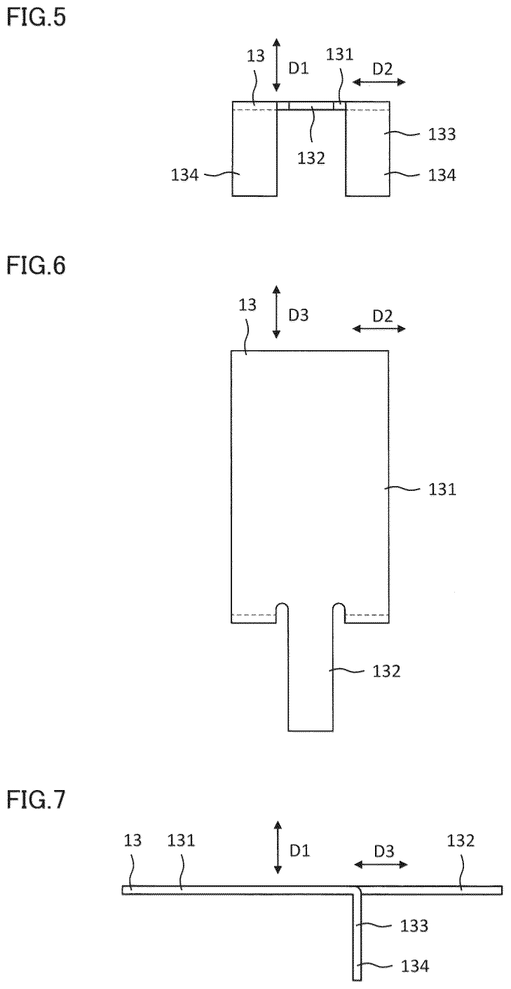

FIG. 5 is a front view for illustrating the level meter 13 of FIG. 3. FIG. 6 is a plan view for illustrating the level meter 13 of FIG. 5. FIG. 7 is a side view for illustrating the level meter 13 of FIG. 5.

The receiving portion 131 is formed in a plate-like shape. The receiving portion 131 is arranged so as to extend along a horizontal plane. The mark portion 132 is formed in a plate-like shape. The receiving portion 131 is arranged so as to be pushed by the counterweight 3 from above.

The mark portion 132 is arranged so as to extend along the horizontal plane. The mark portion 132 is provided to the receiving portion 131. An upper surface of the mark portion 132 is flush with an upper surface of the receiving portion 131.

The guide portion 133 includes a pair of slide plates 134. The pair of slide plates 134 are arranged so as to be spaced apart from each other in the width direction D2. Each of the pair of slide plates 134 is fixed to a lower surface of the receiving portion 131.

As illustrated in FIG. 3 and FIG. 4, when the car 1 is on the top floor, a bottom surface of the counterweight 3, which is located above the receiving portion 131, is in contact with the upper surface of the receiving portion 131.

When the counterweight 3 is located above and in contact with the receiving portion 131, the mark portion 132 indicates a position of the lower end portion of the counterweight 3. The mark portion 132 is inserted from the receiving portion 131 into the slit 601 and passes through the protective cover 6. A distal end portion of the mark portion 132 is located on a side closer to the in-pit work area 702 with respect to the protective cover 6. Thus, the mark portion 132 can be visually checked by the worker 8 who is in the in-pit work area 702.

The pair of slide plates 134 are provided so as to be slidable in the up-and-down direction D1 with respect to a surface of the protective cover 6, which is opposed to the counterweight 3. When the pair of slide plates 134 are slid in the up-and-down direction D1 along the protective cover 6, the receiving portion 131 and the mark portion 132 are moved in the up-and-down direction D1 with respect to the protective cover 6. Thus, the guide portion 133 guides the receiving portion 131 and the mark portion 132 along the protective cover 6. When the pair of slide plates 134 are in contact with the surface of the protective cover 6, which is opposed to the counterweight 3, the arrangement of the receiving portion 131 and the mark portion 132 along the horizontal plane is achieved.

The receiving portion 131, the mark portion 132, and the guide portion 133 are formed integrally. In other words, the level meter 13 is a single member that is made of the same material and is formed integrally and indivisibly.

The holding part 14 is provided and held on the protective cover 6 with a magnetic force. The holding part 14 holds the level meter 13 in such a manner that the level meter 13 is movable in the up-and-down direction D1 with respect to the protective cover 6.

The holding part 14 includes a magnet portion 141 that presses the guide portion 133 against the protective cover 6 with a magnetic force. The magnet portion 141 has a pair of mounting portions 142. The pair of mounting portions 142 are provided so as to correspond to the pair of slide parts 134 in a one-to-one manner.

Each of the mounting portions 142 includes a first magnet 143 and a second magnet 144. Each of the mounting portions 142 holds one of the slide plates 134, which corresponds to the mounting portion 142, in the thickness direction D3.

A surface of each of the slide plates 134, which is opposed to the protective cover 6, is referred to as a first surface 135, and a surface thereof opposite to the protective cover 6 is referred to as a second surface 136. Each of the first magnets 143 is provided on the second surface 136 of one of the slide plates 134, which corresponds to the first magnet 143. Thus, the slide plate 134 corresponding to the first magnet 143 is arranged between the first magnet 143 and the protective cover 6.

Each of the second magnets 144 is provided on a surface of the protective cover 6 that faces the in-pit work area 702. The first magnet 143 and the second magnet 144 of each of the mounting portions 142 overlap each other in the thickness direction D3. The slide plate 134 corresponding to each of the mounting portions 142 and the protective cover 6 are arranged between the first magnet 143 and the second magnet 144 of the mounting portion 142.

In each of the mounting portions 142, the first magnet 143 and the second magnet 144 are magnetized so as to attract each other. The first magnet 143 and the second magnet 144 of each of the mounting portions 142 attract each other to thereby press a corresponding one of the slide plates 134 against the protective cover 6. In other words, the holding part 14 presses the guide portion 133 against the protective cover 6 with the magnetic force.

The holding part 14 presses the guide portion 133 against the protective cover 6 with the magnetic force. As a result, a frictional force is generated between the guide portion 133 and the protective cover 6. When the receiving portion 131 is pushed downward by the counterweight 3, the level meter 13 is moved downward against the frictional force generated between the guide portion 133 and the protective cover 6. When the counterweight 3 is separated away from the receiving portion 131, a position of the level meter 13 is maintained.

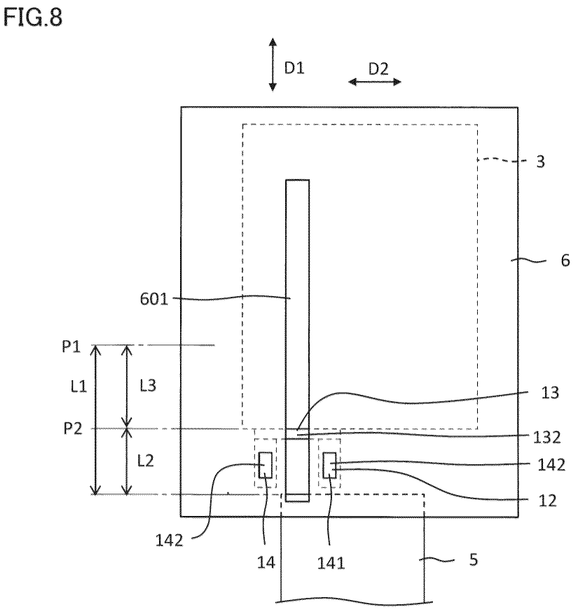

FIG. 8 is a front view for illustrating the clearance measurement device 12 for the counterweight 3 of the elevator according to the first embodiment after aging of the elevator occurs. In FIG. 8, the clearance measurement device 12 for the counterweight 3 of the elevator when the car 1 is on the top floor is illustrated. After the elevator is installed, elongation occurs in the main rope 2 over time. Along with the occurrence of elongation in the main rope 2, a position of the counterweight 3 at the time when the car 1 is on the top floor is shifted downward. As a result, the clearance dimension L for the counterweight 3 is decreased.

A position of the lower end portion of the counterweight 3 when the car 1 is on the top floor immediately after the installation of the elevator is represented by P1. Further, the clearance dimension for the counterweight 3 immediately after the installation of the elevator is represented by L1. A position of the lower end portion of the counterweight 3 when the car 1 is on the top floor after aging of the elevator occurs is represented by P2. Further, a clearance dimension for the counterweight 3 after aging of the elevator occurs is represented by L2.

The position P1 is measured at the time of installation of the elevator. The position P1 is measured, for example, with use of a scale sticker provided on the protective cover 6.

The clearance dimension L1 for the counterweight 3 is measured at the time of installation of the elevator. The clearance dimension L1 for the counterweight 3 is measured before the protective cover 6 is mounted onto the upper mounting arm 10 and the lower mounting arm 11.

The position P2 is regularly measured after the installation of the elevator. The position P2 is measured, for example, with use of a scale sticker provided on the protective cover 6. The position P2 is measured under a state in which the protective cover 6 is mounted on the upper mounting arm 10 and the lower mounting arm 11. Thus, the protective cover 6 is not required to be removed from the upper mounting arm 10 and the lower mounting arm 11.

The clearance dimension L2 for the counterweight 3 is measured every time the position P2 is measured. The clearance dimension L2 for the counterweight 3 is measured by calculating a distance L3 between the position P1 and the position P2 and then subtracting the calculated distance L3 from a value of the clearance dimension L1 for the counterweight 3. Specifically, the clearance dimension L2 for the counterweight 3 is measured by Expression (1).

$$L 3 = L 1 - L 2 \qquad ( 1 )$$

In the above-mentioned manner, the clearance dimension L2 for the counterweight 3 is measured without removal of the protective cover 6 from the upper mounting arm 10 and the lower mounting arm 11.

As described above, the clearance measurement device 12 for the counterweight 3 of the elevator according to the first embodiment includes the level meter 13 and the holding part 14. The holding part 14 is provided to the protective cover 6 and holds the level meter 13 in such a manner that the level meter 13 is movable in the up-and-down direction D1 with respect to the protective cover 6. The level meter 13 includes the receiving portion 131, the mark portion 132, and the guide portion 133. The receiving portion 131 is pushed by the counterweight 3 from above. The mark portion 132 is provided to the receiving portion 131 and indicates the position of the lower end portion of the counterweight 3. The guide portion 133 guides the receiving portion 131 and the mark portion 132 along the protective cover 6. With the configuration described above, when the worker 8 who is in the in-pit work area 702 can visually check the position of the lower end portion of the counterweight 3 by visually checking the position of the mark portion 132. As a result, the clearance dimension L for the counterweight 3 can be measured without removal of the protective cover 6.

Further, in the clearance measurement device 12 for the counterweight 3 of the elevator according to the first embodiment, the protective cover 6 has a slit 601 extending in the up-and-down direction D1. The mark portion 132 is inserted from the receiving portion 131 into the slit 601 and passes through the protective cover 6. With the configuration described above, the simple configuration enables the worker 8 who is in the in-pit work area 702 to visually check the mark portion 132.

Further, in the clearance measurement device 12 for the counterweight 3 of the elevator according to the first embodiment, the holding part 14 includes the magnet portion 141 that presses the guide portion 133 against the protective cover 6 with the magnetic force. When the receiving portion 131 is pushed downward by the counterweight 3, the level meter 13 is moved downward against the frictional force generated between the guide portion 133 and the protective cover 6. With the configuration described above, when the receiving portion 131 is pushed downward by the counterweight 3, the level meter 13 is moved downward. Then, when the counterweight 3 is separated away from the receiving portion 131, the position of the level meter 13 is maintained. Thus, the worker 8 is not required to be present in the in-pit work area 702 when the receiving portion 131 is in contact with the counterweight 3. As a result, the worker 8 can measure the clearance dimension L for the counterweight 3 by visually checking the position of the mark portion 132 regardless of whether or not the receiving portion 131 is in contact with the counterweight 3.

The clearance measurement device 12 for the counterweight 3 of the elevator according to the first embodiment, which has a configuration in which each of the mounting portions 142 includes the first magnet 143 and the second magnet 144, has been described. However, when the protective cover 6 is made of a magnetic material such as iron, each of the mounting portions 142 may include only the first magnet 143 without including the second magnet 144. In this case, the first magnets 143 and the protective cover 6 attract each other at the mounting portions 142 to thereby press the slide plates 134 against the protective cover 6.

### Second Embodiment

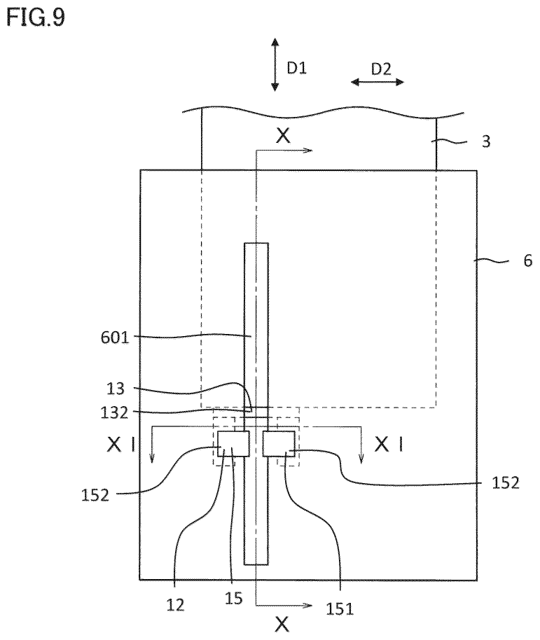

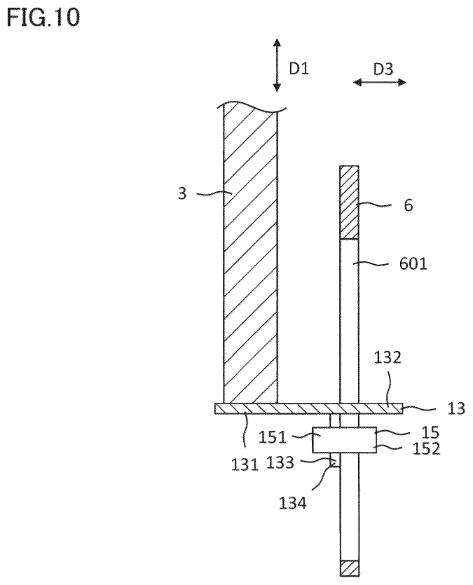

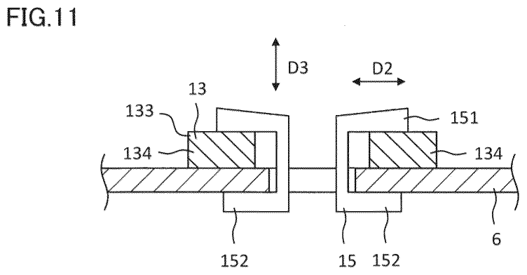

FIG. 9 is a front view for illustrating a clearance measurement device for a counterweight of an elevator according to a second embodiment. FIG. 10 is a sectional view taken along the line X-X of FIG. 9 when viewed in a direction indicated by the arrows. FIG. 11 is a sectional view taken along the line XI-XI of FIG. 9 when viewed in a direction indicated by the arrows. In FIG. 9, FIG. 10, and FIG. 11, the clearance measurement device 12 for the counterweight 3 of the elevator when the car 1 is on the top floor is illustrated.

The clearance measurement device 12 for the counterweight 3 of the elevator according to the second embodiment includes a level meter 13 and a holding part 15. The level meter 13 of the clearance measurement device 12 for the counterweight 3 of the elevator according to the second embodiment is similar to the level meter 13 of the clearance measurement device 12 for the counterweight 3 of the elevator according to the first embodiment.

The holding part 15 is provided and held on a protective cover 6 with an elastic force of the holding part 15. The holding part 15 holds the level meter 13 with the elastic force of the holding part 15.

The holding part 15 includes a spring member 151 that presses the guide portion 133 against the protective cover 6 with an elastic force. The spring member 151 has a pair of flat springs 152. The pair of flat springs 152 are provided so as to correspond to the pair of slide parts 134 in a one-to-one manner. Each of the flat springs 152 holds the slide plate 134 corresponding to the flat spring 152 and the protective cover 6 in the thickness direction D3. When each of the flat springs 152 holds the slide plate 134 corresponding to the flat spring 152 and the protective cover 6 in the thickness direction D3, each of the slide plates 134 is pressed against the protective cover 6. In other words, the holding part 15 presses the guide portion 133 against the protective cover 6 with the elastic force.

The holding part 15 presses the guide portion 133 against the protective cover 6 with the elastic force. As a result, a frictional force is generated between the guide portion 133 and the protective cover 6. When the receiving portion 131 is pushed downward by the counterweight 3, the level meter 13 is moved downward against the frictional force generated between the guide portion 133 and the protective cover 6. When the counterweight 3 is separated away from the receiving portion 131, a position of the level meter 13 is maintained.

Other configurations of the clearance measurement device 12 for the counterweight 3 of the elevator according to the second embodiment are similar to those of the clearance measurement device 12 for the counterweight 3 of the elevator according to the first embodiment.

As described above, in the clearance measurement device 12 for the counterweight 3 of the elevator according to the second embodiment, the holding part 15 includes the spring member 151 that presses the guide portion 133 against the protective cover 6. When the receiving portion 131 is pushed downward by the counterweight 3, the level meter 13 is moved downward against the frictional force generated between the guide portion 133 and the protective cover 6. With the configuration described above, when the receiving portion 131 is pushed downward by the counterweight 3, the level meter 13 is moved downward. Then, when the counterweight 3 is separated away from the receiving portion 131, the position of the level meter 13 is maintained. Thus, the worker 8 is not required to be present in the in-pit work area 702 when the receiving portion 131 is in contact with the counterweight 3. As a result, the worker 8 can measure the clearance dimension L for the counterweight 3 by visually checking the position of the mark portion 132 regardless of whether or not the receiving portion 131 is in contact with the counterweight 3.

### Third Embodiment

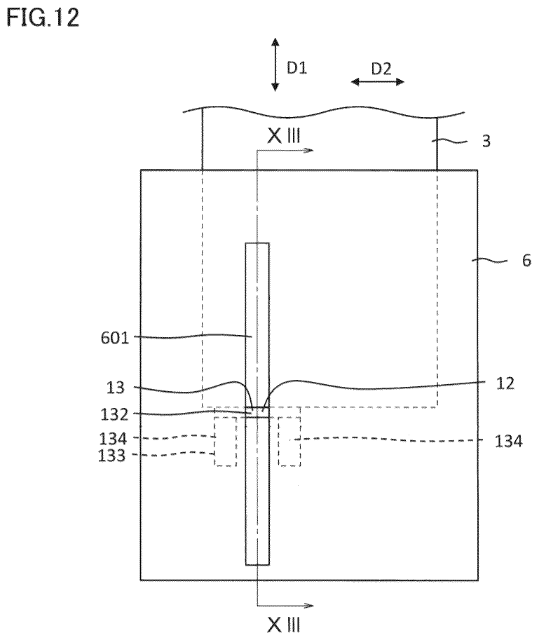

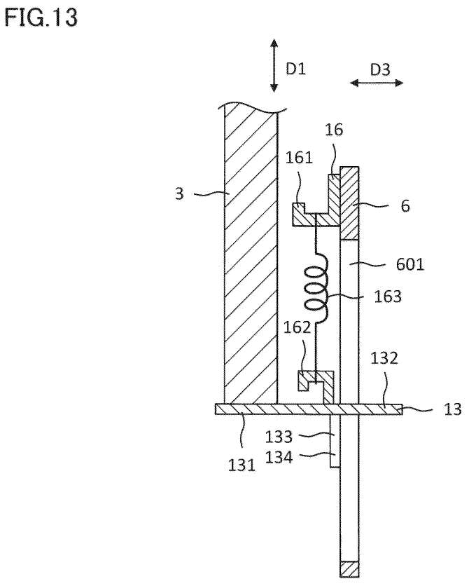

FIG. 12 is a front view for illustrating a clearance measurement device for a counterweight of an elevator according to a third embodiment. FIG. 13 is a sectional view taken along the line XIII-XIII of FIG. 12 when viewed in a direction indicated by the arrows. In FIG. 12 and FIG. 13, the clearance measurement device 12 for the counterweight 3 of the elevator when the car 1 is on the top floor is illustrated.

The clearance measurement device 12 for the counterweight 3 of the elevator according to the third embodiment includes a level meter 13 and a holding part 16. The level meter 13 of the clearance measurement device 12 for the counterweight 3 of the elevator according to the third embodiment is similar to the level meter 13 of the clearance measurement device 12 for the counterweight 3 of the elevator according to the first embodiment.

The holding part 16 is provided on a protective cover 6. The holding part 16 holds the level meter 13.

The holding part 16 includes a first fixing portion 161, a second fixing portion 162, and a spring member 163. The first fixing portion 161 is arranged above the second fixing portion 162. The first fixing portion 161 is mounted to the protective cover 6. The second fixing portion 162 is mounted to the level meter 13. The spring member 163 is provided so as to extend between the first fixing portion 161 and the second fixing portion 162. The spring member 163 is extended and compressed in the up-and-down direction D1. The level meter 13 is supported on the protective cover 6 through intermediation of the spring member 163.

Other configurations of the clearance measurement device 12 for the counterweight 3 of the elevator according to the third embodiment are similar to those of the clearance measurement device 12 for the counterweight 3 of the elevator according to the first embodiment.

As described above, in the clearance measurement device 12 for the counterweight 3 of the elevator according to the third embodiment, the holding part 16 includes the spring member 163 that is extended and compressed in the up-and-down direction D1. The level meter 131 is supported on the protective cover 6 through intermediation of the spring member 163. When the receiving portion 131 is pushed downward by the counterweight 3, the level meter 13 is moved downward against an elastic force of the spring member 163. With the configuration described above, when the receiving portion 131 is pushed downward by the counterweight 3, the level meter 13 is moved downward. Then, when the counterweight 3 is separated away from the receiving portion 131, the level meter 13 returns to its initial position. In the manner described above, reliable contact of the counterweight 3 with the receiving portion 131 at the time of measurement of the clearance dimension L for the counterweight 3 can be achieved. As a result, the clearance dimension L for the counterweight 3 can be reliably measured.

The clearance measurement device 12 for the counterweight 3 of the elevator according to the third embodiment, which has a configuration in which the holding part 16 includes the first fixing portion 161, the second fixing portion 162, and the spring member 163, has been described. However, the holding part 16 may include the spring member 163, and the spring member 163 may be provided so as to extend between the protective cover 6 and the level meter 13. Even with this configuration, the level meter 13 is supported on the protective cover 6 through intermediation of the spring member 163.

### Fourth Embodiment

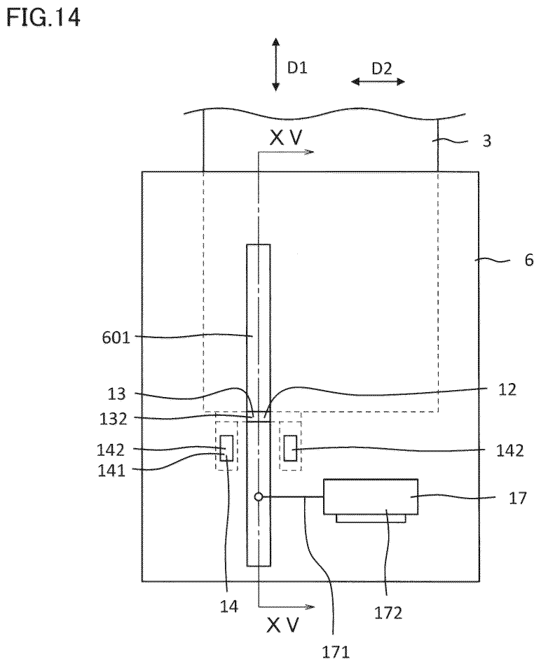

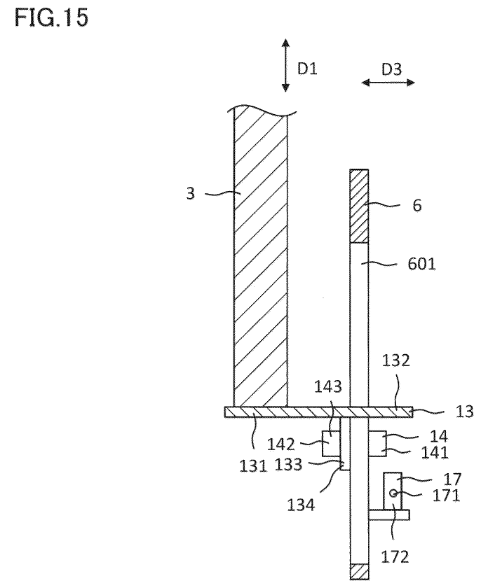

FIG. 14 is a front view for illustrating a clearance measurement device for a counterweight of an elevator according to a fourth embodiment immediately after installation of the elevator. FIG. 15 is a sectional view taken along the line XV-XV of FIG. 14 when viewed in a direction indicated by the arrows. In FIG. 14 and FIG. 15, the clearance measurement device 12 for the counterweight 3 of the elevator when the car 1 is on the top floor is illustrated.

The clearance measurement device 12 for the counterweight 3 of the elevator according to the fourth embodiment includes a level meter 13, a holding part 14, and a detection device 17. The level meter 13 and the holding part 14 of the clearance measurement device 12 for the counterweight 3 of the elevator according to the fourth embodiment are similar to the level meter 13 and the holding part 14 of the clearance measurement device 12 for the counterweight 3 of the elevator according to the first embodiment.

The detection device 17 is provided to the protective cover 6. The detection device 17 includes a lever 171 and a rotation detection device 172.

The lever 171 is supported rotatably by the rotation detection device 172. The lever 171 is arranged at a preset position on a path of movement of a mark portion 132. Thus, when the mark portion 132 is moved downward and reaches the preset position, the mark portion 132 pushes the lever 171 downward. In this manner, the lever 171 is rotated.

The rotation detection device 172 detects the rotation of the lever 171. When the rotation detection device 172 detects the rotation of the lever 171, the detection device 17 detects that the mark portion 132 has reached the preset position.

An elevator control panel (not shown) or a maintenance monitoring panel (not shown) is electrically connected to the detection device 17. A result of detection performed by the detection device 17 is transmitted to the elevator control panel or the maintenance monitoring panel. The result of detection performed by the detection device 17, which has been transmitted to the elevator control panel or the maintenance monitoring panel, is used for maintenance work on the counterweight 3.

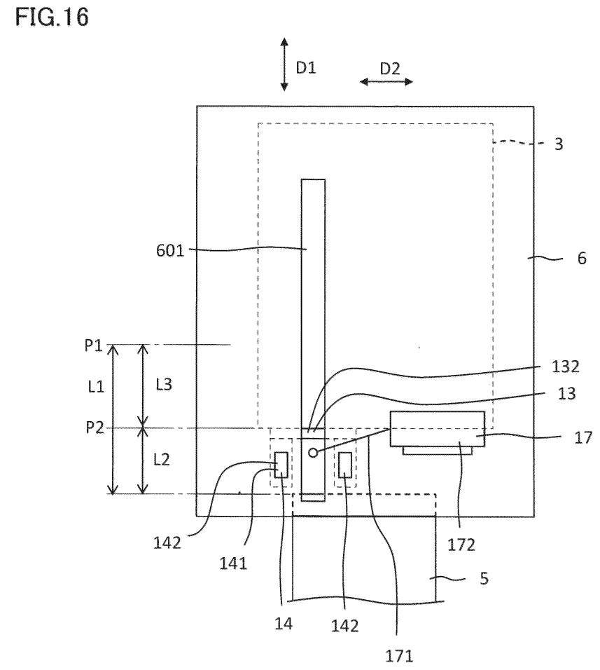

FIG. 16 is a front view for illustrating the clearance measurement device 12 for the counterweight 3 of the elevator according to the fourth embodiment after aging of the elevator occurs. In FIG. 16, the clearance measurement device 12 for the counterweight 3 of the elevator when the car 1 is on the top floor is illustrated. After the elevator is installed, elongation occurs in the main rope 2 over time. Along with the occurrence of elongation in the main rope 2, a position of the counterweight 3 at the time when the car 1 is on the top floor is shifted downward. As a result, the clearance dimension L for the counterweight 3 is decreased.

When the clearance dimension L for the counterweight 3 is decreased and becomes equal to a preset value, the mark portion 132 pushes the lever 171 downward. In this manner, the detection device 17 detects that the mark portion 132 is located at the preset position.

The elevator control panel or the maintenance monitoring panel, to which the result of detection performed by the detection device 17 has been transmitted, informs the worker 8 that the clearance dimension L for the counterweight 3 is required to be measured. Thus, the worker 8 measures the clearance dimension L for the counterweight 3.

Other configurations of the clearance measurement device 12 for the counterweight 3 of the elevator according to the fourth embodiment are similar to those of the clearance measurement device 12 for the counterweight 3 of the elevator according to the first embodiment. Similarly to the clearance measurement device 12 for the counterweight 3 according to the second embodiment, the clearance measurement device 12 may include the holding part 15, which includes the spring member 151 that presses the guide portion 133 against the protective cover 6. Further, similarly to the clearance measurement device 12 for the counterweight 3 according to the third embodiment, the clearance measurement device 12 may include the holding part 16, which includes the spring member 163 that is extended and compressed in the up-and-down direction D1.

As described above, the clearance measurement device 12 for the counterweight 3 of the elevator according to the fourth embodiment further includes the detection device 17 that is provided to the protective cover 6. The detection device 17 detects that the mark portion 132 is located at the preset position. With the configuration described above, the worker 8 can measure the clearance dimension L for the counterweight 3 in accordance with the result of detection performed by the detection device 17. Thus, in comparison to a case in which the clearance dimension L for the counterweight 3 is regularly measured, a frequency of measurement of the clearance dimension L for the counterweight 3 can be reduced. As a result, efficiency in monitoring the clearance dimension L for the counterweight 3 can be improved.

The clearance measurement device 12 for the counterweight 3 of the elevator according to the fourth embodiment, which has a configuration including one detection device 17, has been described. However, the clearance measurement device 12 may include a plurality of detection devices 17. In this case, the plurality of detection devices 17 are arranged vertically at preset positions on the path of movement of the mark portion 132. More specifically, for example, two detection devices 17 are arranged vertically at preset positions on the path of movement of the mark portion 132. When one of the two detection devices 17, which is arranged above the other one, detects that the mark portion 132 is located at a preset first position, the elevator control panel or the maintenance monitoring panel warns the worker 8. Further, when the lower one of the two detection devices 17 detects that the mark portion 132 is located at a preset second position, the elevator control panel or the maintenance monitoring panel informs the worker 8 that an urgent inspection is required to be carried out. Specifically, when the clearance measurement device 12 includes the plurality of detection devices 17, the plurality of detection devices 17 are arranged in accordance with, for example, the order of priority or a monitoring level.

### Fifth Embodiment

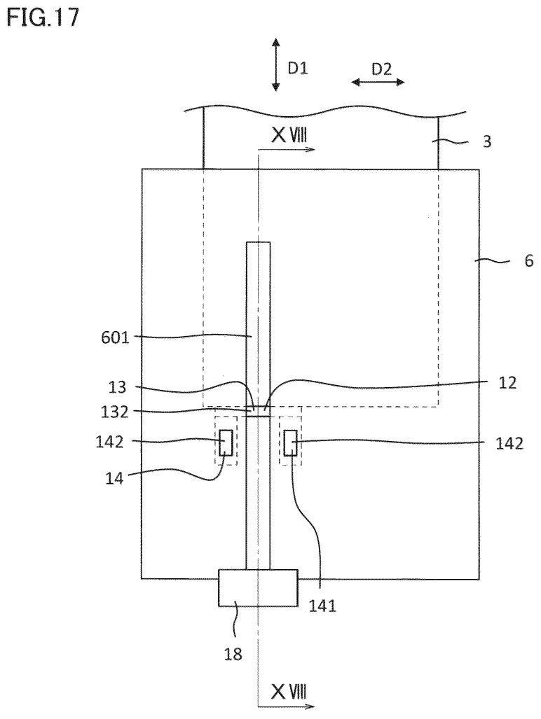

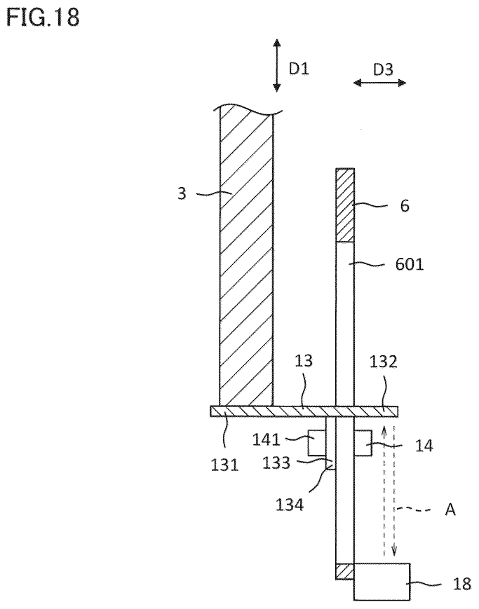

FIG. 17 is a front view for illustrating a clearance measurement device for a counterweight of an elevator according to a fifth embodiment. FIG. 18 is a sectional view taken along the line XVIII-XVIII of FIG. 17 when viewed in a direction indicated by the arrows. In FIG. 17 and FIG. 18, the clearance measurement device 12 for the counterweight 3 of the elevator when the car 1 is on the top floor is illustrated.

The clearance measurement device 12 for the counterweight 3 of the elevator according to the fifth embodiment includes a level meter 13, a holding part 14, and a distance measurement device 18. The level meter 13 and the holding part 14 of the clearance measurement device 12 for the counterweight 3 of the elevator according to the fifth embodiment are similar to the level meter 13 and the holding part 14 of the clearance measurement device 12 for the counterweight 3 of the elevator according to the first embodiment.

The distance measurement device 18 is provided to a protective cover 6 so as to be spaced apart from a mark portion 132 in the up-and-down direction D11. The distance measurement device 18 measures a distance from the distance measurement device 18 to the mark portion 132. Arrows A in FIG. 18 indicate a state in which the distance measurement device 18 is measuring the distance from the distance measurement device 18 to the mark portion 132. The distance measurement device 18 is arranged below the mark portion 132. The distance from the distance measurement device 18 to the mark portion 132 is measured by the distance measurement device 18 with, for example, an infrared method or an ultrasonic method. The distance from the distance measurement device 18 to the mark portion 132 is regularly measured by the distance measurement device 18.

An elevator control panel (not shown) or a maintenance monitoring panel (not shown) is electrically connected to the distance measurement device 18. A result of measurement performed by the distance measurement device 18 is transmitted to the elevator control panel or the maintenance monitoring panel. The result of measurement performed by the distance measurement device 18, which has been transmitted to the elevator control panel or the maintenance monitoring panel, is used for maintenance work on the counterweight 3.

The elevator control panel or the maintenance monitoring panel, to which the result of measurement performed by the distance measurement device 18 is transmitted, monitors a time-series change in the result of measurement performed by the distance measurement device 18. Values associated with the clearance dimension L for the counterweight 3 are set in advance in the elevator control panel or the maintenance monitoring panel. When the clearance dimension L for the counterweight 3 is decreased and becomes equal to a preset value, the elevator control panel or the maintenance monitoring panel detects that the mark portion 132 is located at a preset position.

The elevator control panel or the maintenance monitoring panel informs the worker 8, based on the result of detection performed by the elevator control panel or the maintenance monitoring panel, that maintenance is required for the counterweight 3. Thus, the worker 8 performs maintenance on the counterweight 3.

Other configurations of the clearance measurement device 12 for the counterweight 3 of the elevator according to the fifth embodiment are similar to those of the clearance measurement device 12 for the counterweight 3 of the elevator according to the first embodiment. Similarly to the clearance measurement device 12 for the counterweight 3 according to the second embodiment, the clearance measurement device 12 may include the holding part 15, which includes the spring member 151 that presses the guide portion 133 against the protective cover 6. Further, similarly to the clearance measurement device 12 for the counterweight 3 according to the third embodiment, the clearance measurement device 12 may include the holding part 16, which includes the spring member 163 that is extended and compressed in the up-and-down direction D1.

As described above, the clearance measurement device 12 for the counterweight 3 of the elevator according to the fifth embodiment further includes the distance measurement device 18 that is provided to the protective cover 6 so as to be spaced apart from the mark portion 132 in the up-and-down direction D1. The distance measurement device 18 measures the distance from the distance measurement device 18 to the mark portion 132. With the configuration described above, the worker 8 can measure the clearance dimension L for the counterweight 3 without entering an in-pit work area 702.

### REFERENCE SIGNS LIST

1 car, 2 main rope, 3 counterweight, 4 hoisting machine, 5 counterweight buffer, 6 protective cover, 7 hoistway, 8 worker, 9 counterweight guide rail, 10 upper mounting arm, 11 lower mounting arm, 12 clearance measurement device, 13 level meter, 14 holding part, 15 holding part, 16 holding part, 17 detection device, 18 distance measurement device, 131 receiving portion, 132 mark portion, 133 guide portion, 134 slide plate, 135 first surface, 136 second surface, 141 magnet portion, 142 mounting portion, 143 first magnet, 144 second magnet, 151 spring member, 152 flat spring, 161 first fixing portion, 162 second fixing portion, 163 spring member, 171 lever, 172 rotation detection device, 601 slit, 701 pit, 702 in-pit work area.

1. A clearance measurement device for a counterweight of an elevator, comprising:
a level meter; and
a holding part that is provided to a protective cover and holds the level meter in such a manner that the level meter is movable in an up-and-down direction with respect to the protective cover,
wherein the level meter includes:
a receiving portion to be pushed by a counterweight from above;
a mark portion that is provided to the receiving portion and is configured to indicate a position of a lower end portion of the counterweight; and
a guide portion configured to guide the receiving portion and the mark portion along the protective cover.

2. The clearance measurement device for a counterweight of an elevator according to claim 1,
wherein the protective cover has a slit extending in the up-and-down direction, and
wherein the mark portion is inserted from the receiving portion into the slit and passes through the protective cover.

3. The clearance measurement device for a counterweight of an elevator according to claim 1,
wherein the holding part includes a magnet portion configured to press the guide portion against the protective cover with a magnetic force, and
wherein, when the receiving portion is pushed downward by the counterweight, the level meter is moved downward against a frictional force generated between the guide portion and the protective cover.

4. The clearance measurement device for a counterweight of an elevator according to claim 1,
wherein the holding part includes a spring member configured to press the guide portion against the protective cover with an elastic force, and
wherein, when the receiving portion is pushed downward by the counterweight, the level meter is moved downward against a frictional force generated between the guide portion and the protective cover.

5. The clearance measurement device for a counterweight of an elevator according to claim 1,
wherein the holding part includes a spring member that is extended and compressed in the up-and-down direction,
wherein the level meter is supported on the protective cover through intermediation of the spring member, and
wherein, when the receiving portion is pushed downward by the counterweight, the level meter is moved downward against an elastic force of the spring member.

6. The clearance measurement device for a counterweight of an elevator according to claim 1, further comprising a detection device that is provided to the protective cover and is configured to detect that the mark portion is located at a preset position.

7. The clearance measurement device for a counterweight of an elevator according to claim 1, further comprising a distance measurement device that is provided to the protective cover so as to be spaced apart from the mark portion in the up-and-down direction and is configured to measure a distance to the mark portion.
